(19) United States
(12) Patent Application Publication
(10) Pub. No.: US 2013/0191163 A1
(43) Pub. Date: Jul. 25, 2013

(54) HEALTH RECORD WITH INBOUND AND OUTBOUND FAX FUNCTIONALITY

(71) Applicant: MyMedicalRecords, Inc., Los Angeles, CA (US)

(72) Inventor: Robert H. Lorsch, Los Angeles, CA (US)

(21) Appl. No.: 13/792,656

(22) Filed: Mar. 11, 2013

Related U.S. Application Data
(63) Continuation-in-part of application No. 13/663,101, filed on Oct. 29, 2012.
Application No. 13/663,101 is a continuation of application No. 13/041,809, filed on Mar. 7, 2011, now Pat. No. 8,301,466.
Application No. 13/041,809 is a continuation of application No. 12/204,465, filed on Sep. 4, 2008, now Pat. No. 8,117,646.
Application No. 12/204,465 is a continuation of application No. 11/305,685, filed on Dec. 16, 2005, now Pat. No. 8,117,045.
Application No. 11/305,685 is a continuation-in-part of application No. 11/225,518, filed on Sep. 12, 2005, now Pat. No. 8,121,855.
(60) Provisional application No. 61/662,417, filed on Jun. 21, 2012.

(51) Int. Cl. G06Q 10/10; G06Q 50/24

(52) U.S. Cl. CPC G06Q 10/10; G06Q 50/24
USPC 705/3

(57) ABSTRACT

A method for receiving a fax into an electronic health record includes receiving a fax transmission at a fax server, generating an image file containing the fax document, generating metadata about the image file and/or the fax transmission, sending the image file and the metadata to a health information technology system, and adding or creating an electronic health record associated with the health information technology system such that the electronic health comprises the image file and/or information derived from the image file. A method for sending a fax based on an electronic health record within a health information technology is also provided.

### PRIORITY STATEMENT

This application claims priority under 35 U.S.C. 119 to U.S. Ser. No. 61/662,417 filed Jun. 21, 2012, hereby incorporated by reference in its entirety.

This application is also a Continuation-in-part of U.S. Ser. No. 13/663,101 filed Oct. 29, 2002 which is a Continuation Application of U.S. Ser. No. 13/041,809 filed Mar. 7, 2012, which is a Continuation Application of U. S. Ser. No. 12/204,465 filed Sep. 4, 2008, now U.S. Pat. No. 8,117,646 issued on Feb. 14, 2012, which is a Continuation of U.S. Ser. No. 11/305,685 filed Dec. 16, 2005, now U.S. Pat. No. 8,117,045 issued on Feb. 14, 2012, which is a Continuation-in-part of and claims priority to U.S. patent application Ser. No. 11/225,518, filed Sep. 12, 2005, now U.S. Pat. No. 8,121,855 issued on Feb. 21, 2012, all of which are hereby incorporated by reference in their entirety.

### FIELD OF THE INVENTION

The present invention relates to personal health records. More particularly, but not exclusively the present invention relates to the delivery of faxes to and from electronic medical records or electronic health records into a personal health records (PHR) management system.

### BACKGROUND OF THE INVENTION

Various health care information systems provide for electronic medical records (EMRs) or electronic health records (EHRs) or personal health records (PHRs). Yet there are various problems associated with such systems.

One of the problems relates to interoperability. Such systems are not necessarily compatible with each other and thus not able to share data. A further problem is that not all health care providers necessarily use electronic medical records or electronic health records and instead use paper-based systems. A further problem relates to sharing electronic information with patients who would not have such systems. What is needed is a way to make such records available to patients regardless the type of health care information system.

### BRIEF SUMMARY OF THE INVENTION

Therefore it is a primary object, feature, or advantage of the present invention to improve upon the state of the art.

It is a further object, feature, or advantage of the present invention to facilitate health care personnel's compliance with HIPAA or other legal requirements regarding privacy of medical records.

A still further object, feature, or advantage of the present invention is to provide an individual with meaningful access to their healthcare records thereby allowing the individual to exercise their legal rights with respect to controlling access to their medical records.

Yet another object, feature, or advantage of the present invention is providing individuals with immediate access to healthcare records in emergency situations to assist in providing appropriate care.

A further object, feature, or advantage of the present invention is to provide a convenient and cost effective method for healthcare providers to comply with laws regarding privacy of healthcare records.

A still further object, feature, or advantage of the present invention is to provide a convenient and cost effective method for individuals to request that their healthcare providers provide copies of medical records.

Another object, feature, or advantage of the present invention is to provide a private communications link between healthcare personnel and their patients.

Yet another object, feature, or advantage of the present invention is to provide for placing an individual in control of their medical records and allowing them to selectively provide access to others.

A still further object, feature, or advantage of the present invention is to facilitate storing all of an individual or family's medical records and related information in a single location so that healthcare personnel can be given complete medical information/history when needed or analysis can be performed on the medical records.

Another object, feature, or advantage of the present invention is to provide a means for individuals to create calendars to remind them of the need to refill prescriptions.

Yet another object, feature, or advantage of the present invention is to provide a means for individuals to create calendars to maintain doctor's appointments.

A further object, feature, or advantage of the present invention is to provide reminder messages regarding the need to refill prescriptions or remember doctor's appointments.

A still further object, feature, or advantage of the present invention is to provide a method to store, organize, and annotate medical records and also to customize the storage by giving the user the ability to name the folders in which those records are stored.

Another object, feature, or advantage of the present invention is to give users the ability to upload images, such as x-rays or scans.

Yet another object, feature, or advantage of the present invention is to give users the ability to forward records via fax to a healthcare provider.

A further object, feature, or advantage of the present invention is to give users the ability to see if there are any possible interactions between prescription drugs they are taking

A further object, feature, or advantage of the present invention is to provide a means for individuals to store and access not only medical records, but other types of health records including dental records, healthcare records associated with pets, and vital documents, including, without limitation, wills, living wills, a power of attorney, and a healthcare power of attorney.

A still further object, feature, or advantage of the present invention is to improver interoperability of health record systems.

Yet another object, feature, or advantage of the present invention is to allow for the healthcare provider to quickly and easily, yet securely, communicate records associated with an individual to the individual.

It is a further object, feature, or advantage of the present invention to make data stored in electronic health records available to patients, or other health care providers who may not use the same EHR/EMR/PHR platform or system.

It is a still further object, feature, or advantage of the present invention to make data stored in electronic health records available to patients or other health care providers who may not use any type of EHR/EMR/PHR platform or system.

Another object, feature, or advantage of the present invention is to provide for placing fax documents or data derived from fax documents into a record of an EHR/EMR/PHR platform or system.

One or more of these and/or other objects, features, or advantages will become apparent from the specification and claims that follow. No single embodiment need exhibit each of these objects, features, or advantages.

According to one aspect of the present invention, a method for providing a consumer with the ability to access and collect personal health records associated with the consumer is provided. The method includes assigning a phone number individually associated with the consumer for fax and voice communications from a healthcare provider and associating access information with the consumer for the consumer to use to access a secure web site. The consumer is provided with a document to provide to the healthcare provider exercising legal rights of the consumer for access to the health records, the document requesting the healthcare provider to send the health records to the phone number. The method further provides for receiving a private fax communication comprising a personal health record associated with the consumer for which the consumer has requested and given permission to the healthcare provider to send, converting the private fax communications into an image file format (such as a PDF), storing the health record encoded in the image file format, and providing the consumer with secure access to the web site using the access information and providing on the web site an interface to the health records of the consumer for the consumer to access the health record.

The document may include an adhesive or be a sticker so that it can be easily attached to the health records. An emergency access card which includes access information and can be used by a third-party to access the health record associated with the consumer in the event of a medical emergency associated with the consumer can also be provided.

The web site interface preferably allows for organizing health records into separate file folders with functionality for the consumer to name the file folders and add file folders as well as provide additional password protection for the file folders.

According to another aspect of the present invention a kit is provided for assisting a customer with exercising rights to health records associated with the customer, accessing the health records, maintaining the health records as private, and providing access to the health records in case of emergency. The kit includes an access card comprising access information associated with the customer to be used to access a secure web site providing access to health records of the customer to be used to convey the access information to another in event of a medical emergency associated with the customer. The kit also includes at least one sticker exercising legal rights of the customer to healthcare records and comprising instructions to a healthcare provider to electronically send the health records to a destination and wherein the health records sent to the destination are accessible on the secure web site.

According to one aspect of the present invention, a method is provided for providing a user with the ability to access and collect records associated with the user in a secure and private manner. The method includes assigning a phone number to the user for private fax and voice communications from service providers, associating access information with the user for the user to use to access a web site, receiving a private fax communication comprising a record associated with the user for which the user has requested and given permission to the service provider to send to the phone number; converting the private fax communications into an image file format, storing the record encoded in the image file format, providing the user with access to the web site using the access information and providing on the web site an interface to the records of the user for the user to access the record, and wherein the web site interface further provides for organizing and annotating the records by the user into separate file folders with functionality for the user to name the file folders and add file folders.

According to another aspect of the present invention a, kit is provided for assisting a user with exercising rights to records associated with the user and created by a service provider, accessing the records, maintaining the records as private, and providing access to the records in case of emergency. The kit includes an access card comprising access information associated with the user to be used to access a secure web site providing access to records of the user to be used to convey the access information to another in event of an emergency associated with the user and at least one document comprising a request to a service provider to electronically send the records to a destination and granting permission by the user to the service provider to electronically send the records to the destination and wherein the records sent to the destination are accessible on the secure web site.

According to another aspect of the present invention a system for communicating records of a user, the system includes a consent document providing instructions for and giving permission to a service provider to fax records of a user to a dedicated phone number associated with the user, a fax server for receiving faxes of the records directed to the dedicated phone number, a web server in operative communication with the fax server and adapted to provide a secure web-based interface to the records, and wherein the web-based interface provides for organizing and annotating the records by the user into separate file folders with functionality for the user to name the file folders and add file folders.

According to another aspect of the present invention, a method for providing a user with the ability to access and collect records associated with the user in a private manner is provided. The method includes assigning a destination address associated with a user for private fax communications from a service provider, associating access information with the user for the user to use to access a web site, receiving a private fax communication comprising a record associated with the user for which the user has requested and given permission to the service provider to send to a fax number, converting the record into an image file format, storing the record encoded in the image file format, associating the record encoded in the image file format with a user account of the user, and providing the user with access to the user account on the web site using the access information. The web site provides an interface to the user for organizing and annotating the into separate file folders with functionality for the user to name the file folders and add file folders.

According to another aspect of the present invention, a method for providing a user with functionality for accessing and collecting records associated with the user is provided. The method includes associating access information with the user to use to access a web site, receiving a record encoded in an image file format from a service provider, automatically determining a user account associated with the record and associating the record with the user account, and providing the user with access to the user account on the web site using the access information. The record encoded in the image file format is a representation of a faxed communication from the service provider.

According to another aspect of the present invention, a method for providing a user with the ability to access and collect records associated with the user in a secure and private manner is provided. The method includes assigning an identifier to the user for private fax and voice communications from service providers, associating access information with the user for the user to use to access a web site, receiving a plurality of private fax communications from different providers, each of the private fax communications comprising a record associated with the user for which the user has requested and given permission to the service provider to send to the phone number, converting the private fax communications into image file formats, storing the records encoded in the image file formats, and providing the user with access to the web site using the access information and providing on the web site an interface to the records of the user for the user to use to access the record. The interface provides for organizing the records into folders, creating additional folders, and naming the folders.

According to one aspect of the present invention, a method for receiving a fax into an electronic health record (EHR/EMR/PHR) is provided. The method includes receiving a fax transmission at a fax server, generating an image file containing the fax document, generating metadata about the image file and/or the fax transmission, sending the image file and the metadata to a health information technology system, and adding or creating an electronic health record associated with the health information technology system such that the electronic health comprises the image file and/or information derived from the image file.

According to another aspect of the present invention, a method for sending a fax based on an electronic health record within a health information technology system is provided. The method includes identifying health data in one or more electronic health record within the health information technology system to send, generating an image file containing the health data, generating header data associated with the image file, sending the image file and the header data to a fax server, and faxing the image file to one or more phone numbers associated with recipients.

According to another aspect of the present invention, a system for receiving and/or sending a fax from an EHR/EMR/PHR platform or system is provided.

According to another aspect of the present invention, a method for providing a user with the ability to access and collect health records associated with the user in a secure and private manner is provided. The method includes associating access information with the user for the user to use to access a server storing files comprising health records associated with the user in a computer readable storage medium. The method further includes providing the user with a user interface on a computing device to remotely access the health records stored on the server, receiving at the server the files comprising the health records associated with the user from a health care provider associated with the user, wherein the files include files generated from a fax transmission and wherein meta data associated with the files identifies the user. The method further includes receiving at the server a request from the user made through the user interface of the computing device for access to the files, wherein the access information is associated with the request, sending the user a file containing the health records associated with user from the server to the computing device in response to the request, and wherein the files are maintained on the server independently from any files maintained by the health care provider and wherein the files are managed privately by the user independently from the health care provider.

According to another aspect, a method for receiving a fax into a personal health record is provided. The method includes receiving a fax transmission at a fax server, the fax transmission including a faxed document, generating an image file containing the fax document, generating meta data about the image file and/or the fax transmission, sending the image file and the meta data to a health information technology system, and adding or creating a personal health record associated with the health information technology system using a computer associated with the health information technology system such that the personal health record comprises the image file and/or information derived from the image file.

### BRIEF DESCRIPTION OF THE DRAWINGS

FIG. 1 is diagram illustrating one embodiment of a system of the present invention.

FIG. 2 is a pictorial representation of a sticker authorizing transmissions of records to the user account according to one embodiment of the present invention.

FIG. 3A and FIG. 3B illustrate a card with medical record access information according to one embodiment of the present invention.

FIG. 4 is a diagram illustrating one embodiment of a system of the present invention.

FIG. 5A and FIG. 5B are flow diagrams illustrating an enrollment process according to one embodiment of the present invention.

FIG. 6 is a flow diagram for accessing records according to one embodiment of the present invention.

FIG. 7 is a screen display of a web site according to one embodiment of the present invention.

FIG. 8 is another screen display of a web site according to one embodiment of the present invention.

FIG. 9 is a screen display according to one embodiment.

FIG. 10 is a screen display for folder administration according to another embodiment.

FIG. 11 is a screen display for an uploaded file feature according to another embodiment of the present invention.

FIG. 12 is a pictorial representation of a preferred embodiment of a sticker providing instructions for faxing medical records.

FIGS. 13 and 14 are pictorial representations of a preferred embodiment of a wallet card which can be used according to the present invention.

FIG. 15 is diagram illustrating one embodiment of drug interacting reporting and analysis of the present invention.

FIG. 16 is a diagram illustrating one embodiment of a system for faxing into or from PHRs/EHRs/EMRs.

FIG. 17 is a diagram illustrating one example of a method for sending a fax from a PHRs/EHRs/EMR.

FIG. 18 is a diagram illustrating one example of a method for receiving a fax into PHRs/EHRs/EMR.

### DETAILED DESCRIPTION OF THE PREFERRED EMBODIMENT

A convenient method for individuals to collect and store their private medical information and to provide private communications between the individual and their healthcare providers is provided. One of the ways collecting and storing private medical information and facilitates private communications is through use of a LIFELINE which is a dedicated toll-free number for fax and voice communications. This dedicated toll-free number provides direct and private communications between a healthcare provider and their patient so that a healthcare provider can be assured that they are maintaining patient communications in secret and to avoid violating applicable privacy laws or patient expectations regarding privacy.

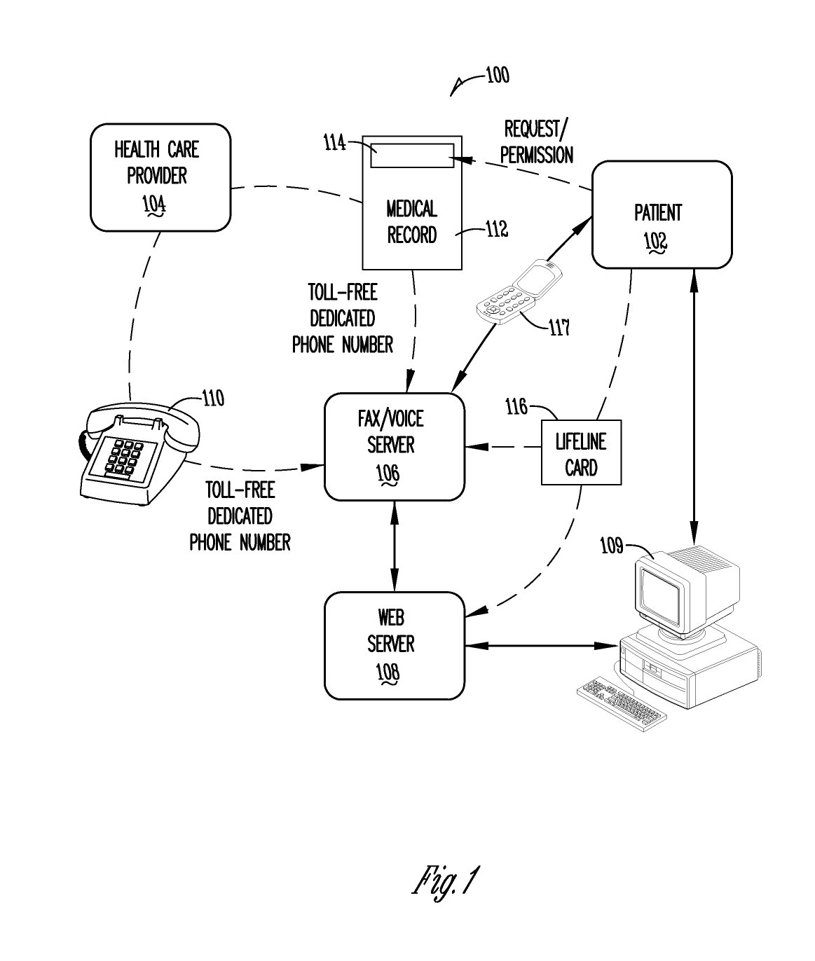

FIG. 1 is a diagram illustrating one embodiment of a system 100 of the present invention. In FIG. 1, a consumer or patient 102 is shown. A healthcare provider 104 is also shown as well as a fax/voice server 106. A web server 108 is operatively connected to the fax/voice server 106. The healthcare provider 104 uses the phone 110 to communicate private voicemail messages through a toll-free dedicated phone number to the fax/voice server 106. In addition, the healthcare provider faxes health or medical records 112 to the fax/voice server 106 using the toll-free dedicated phone number. The medical record 112 preferably has a sticker 114 present on the medical record 112. The sticker 114 indicates or instructs the healthcare provider 104 or their staff to fax the information to the toll-free dedicated phone number. In addition, the sticker 114 provides an indication of clear consent from the patient 102 to the healthcare provider 104 to the toll-free dedicated phone number. Thus, it becomes a simple process for a consumer or patient 102 to provide their healthcare provider 104 with instructions to fax health records, a simple process for the healthcare provider 104 to obtain permission to fulfill a request for healthcare records, and a simple process for the healthcare provider 104 to do so in a secure and convenient manner as the fax is going directly to a toll-free dedicated phone number associated with the patient 102.

The web server 108 is operatively connected to the fax/voice server 106 such as over a network or otherwise. A patient 102 or their proxy can communicate directly with the web server 108 through a computing device 109 or the fax/voice server 106 using a phone 117. The patient 102 can use a LIFELINE card 116 that contains access information to log on to the web server 108 associated with a web site of the present invention, or as a reminder of their toll free dedicated phone number which they can call to access voicemail messages, listen to text-to-speech conversion of emails, or otherwise access information.

The present invention also allows a patient 102 to upload files using a computing device 109 to the web server 108. In addition, the patient 102 can use the computing device 109 to interact with the web server 108 to specify that a prescription or other personal health record is faxed via the fax/voice server 106 to a healthcare provider 104.

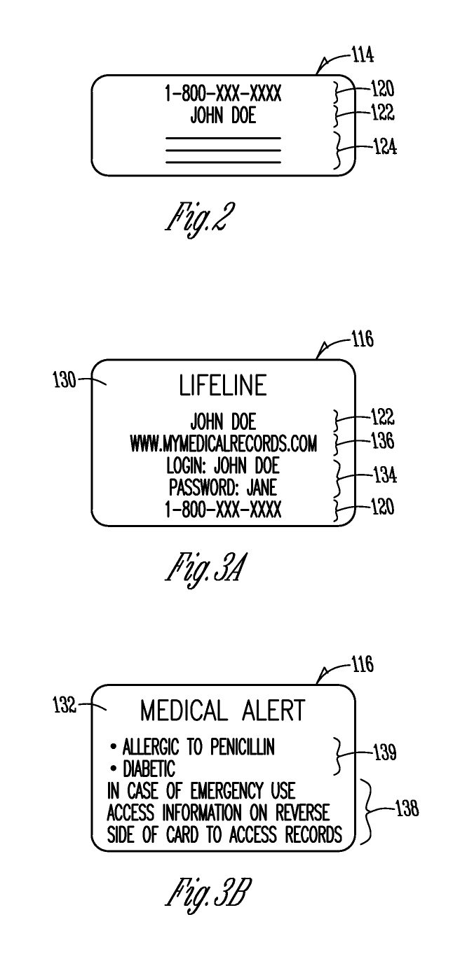

FIG. 2 illustrates one embodiment of a sticker 114 for a patient to give to their healthcare provider to request or instruct their healthcare provider to fax medical records to the toll free dedicated phone number associated with the patient. Although it is preferred that a sticker 114 be used because of the added convenience provided by being able to permanently or semi-permanently attach to a patient file at a healthcare providers office, the present invention contemplates that other types of documents could be used. The sticker 114 includes the LIFELINE phone number 120 which is the toll free dedicated phone number associated with the patient. Note that there is no pin number required which greatly simplifies the process of faxing documents. In addition, the name 122 of the patient is shown. There is also a written request 124 on the sticker 114 that instructs the healthcare provider to fax the records and explicitly gives permission to fax the healthcare record. The language of the written request 124 may vary as necessary to comply with any applicable laws. It should be appreciated that the sticker 114 provides great convenience to both an individual who wants to instruct their healthcare provider to give them access to their medical records as well as to the healthcare provider who can now easily provide the individual with access to their medical records. The present invention further contemplates that medical alert information can also be placed on the sticker 114. The types of medical alert information includes, without limitation, blood type information (i.e. ABO and Rhesus information), allergies to drugs, presence of a pacemaker, diabetes, epilepsy, or other conditions.

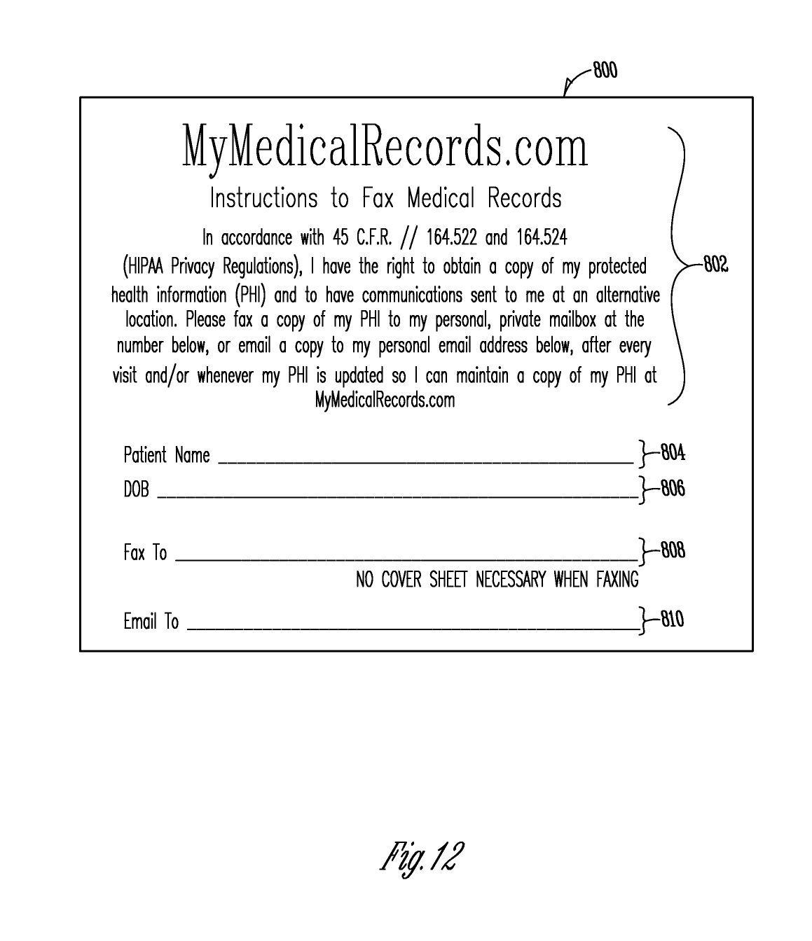

FIG. 12 illustrates another embodiment of such a sticker. Note that in FIG. 12, a sticker 800 is shown. The sticker 800 includes instructions to fax or email medical records 802 which serve to exercise a patients rights under 45 C.F.R. §164.522 and 45 C.F.R. §164.524 (HIPAA Privacy Regulations) to obtain a copy of their protected health information (PHI) and to have such communications sent to the patient at an alternative location. In particular, the instructions 802 instruct the healthcare provider to fax a copy of the PHI to a personal, private mailbox at a toll-free or local number after every visit and/or whenever the PHI is updated so that the patient can maintain a copy of their PHI. Alternatively, the instructions 802 provide for instructing the healthcare provider to email the records to specified email address 810.

The sticker 800 includes a region 804 for the patient to print or type their name and a region 806 for the patient to print or type their date of birth. There is also a region 808 for the fax number to which medical records are delivered. Preferably, the number is a toll-free fax or local number assigned to the patient. There is also a region 810 for an email address to which the medical records are to be submitted.

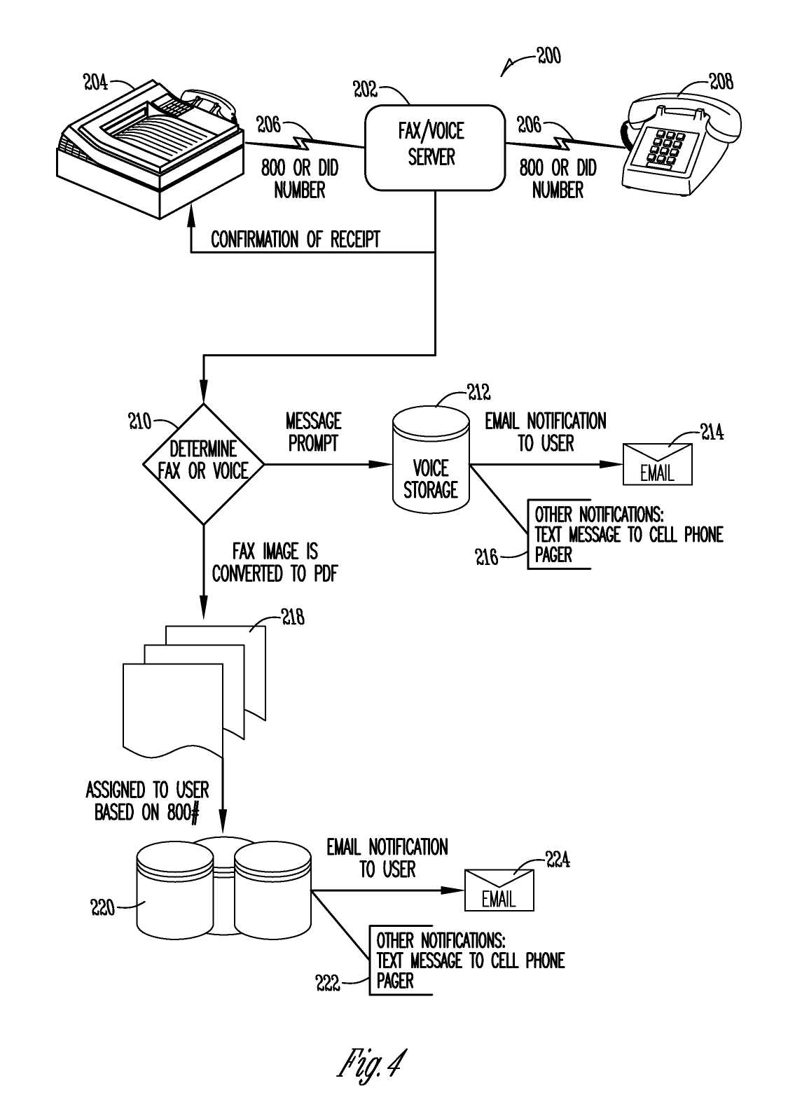

FIG. 3A and FIG. 3B illustrate one embodiment of a LIFELINE card 116. The LIFELINE card has a front side 130 and an opposite back side 132. The card 116 includes the name of the individual 122, a URL for a web site 136 which stores medical records for the individual. In addition there is access information 134 such a username and password. The card 116 also includes the toll free dedicated phone number 120 associated with the individual. On the back side 132 of the card 116 as best shown in FIG. 3B, medical alert information 139 is provided. The medical alert information 139 can include allergies which the individual has, medical conditions such as diabetes or epilepsy, the presence of a pacemaker, or other medical information that may be of great importance in evaluating or treating the individual in the case of a medical emergency. The medical alert information can further include blood type information (i.e. ABO and Rhesus information). Also, instructions 138 are provided on the card 116 to indicate how one could access complete medical records or information about the individual.

The present invention contemplates including the sticker 114 (or other permission/request document) and the LIFELINE card 116 in a welcome kit when an individual or family subscribes or signs-up for the service. In addition, from the web site associated with the service, preferably addition stickers and/or additional cards can be printed and information can be updated as necessary.

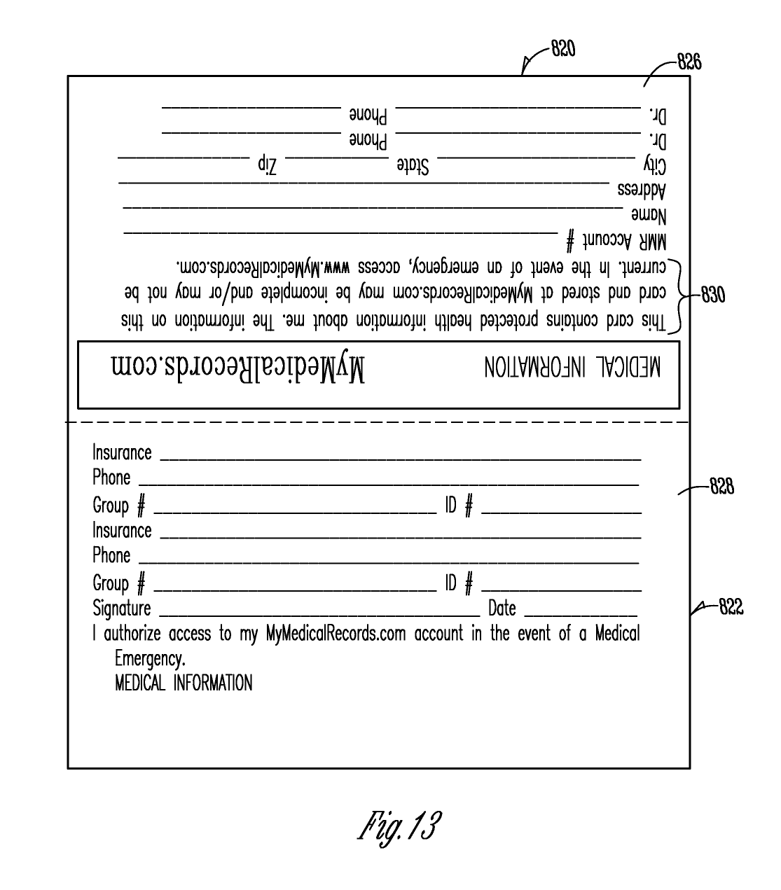

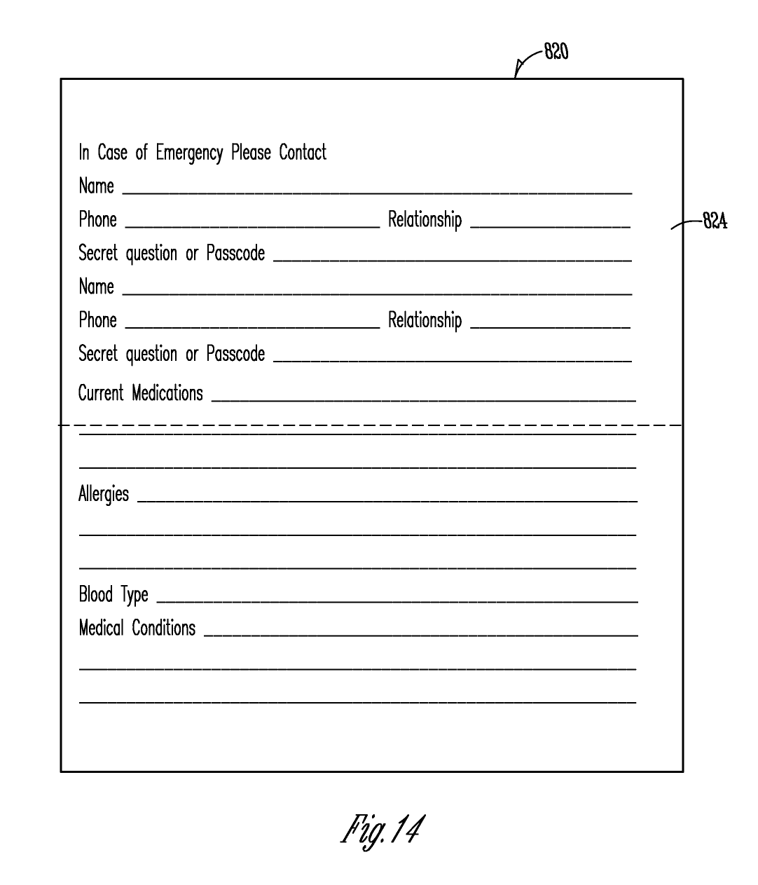

FIGS. 13 and 14 illustrate another embodiment of a wallet card of the present invention. The wallet card 820 includes a first side 822 and an opposite second side 824. As shown in FIG. 13, the first side 822 of the wallet card 820 has a first panel 826 and a second panel 828. The first panel 826 includes identifying information about an individual and emergency instructions 830. The emergency instructions 830 indicate that protected health information can be accessed, in an emergency, at a web site. The second panel 828 of the first side 822 of the wallet card 820 includes insurance information and signature of the patient.

As best shown in FIG. 14, the second side 824 of the wallet card 820 includes emergency contact information, including a secret question or passcode so that the emergency contact person can better verify that there is an emergency, and not a fraudulent notification. The second side 824 of the wallet card 820, also preferably includes information regarding current medications, allergies, blood type, and medical conditions which may be critical to providing appropriate emergency care.

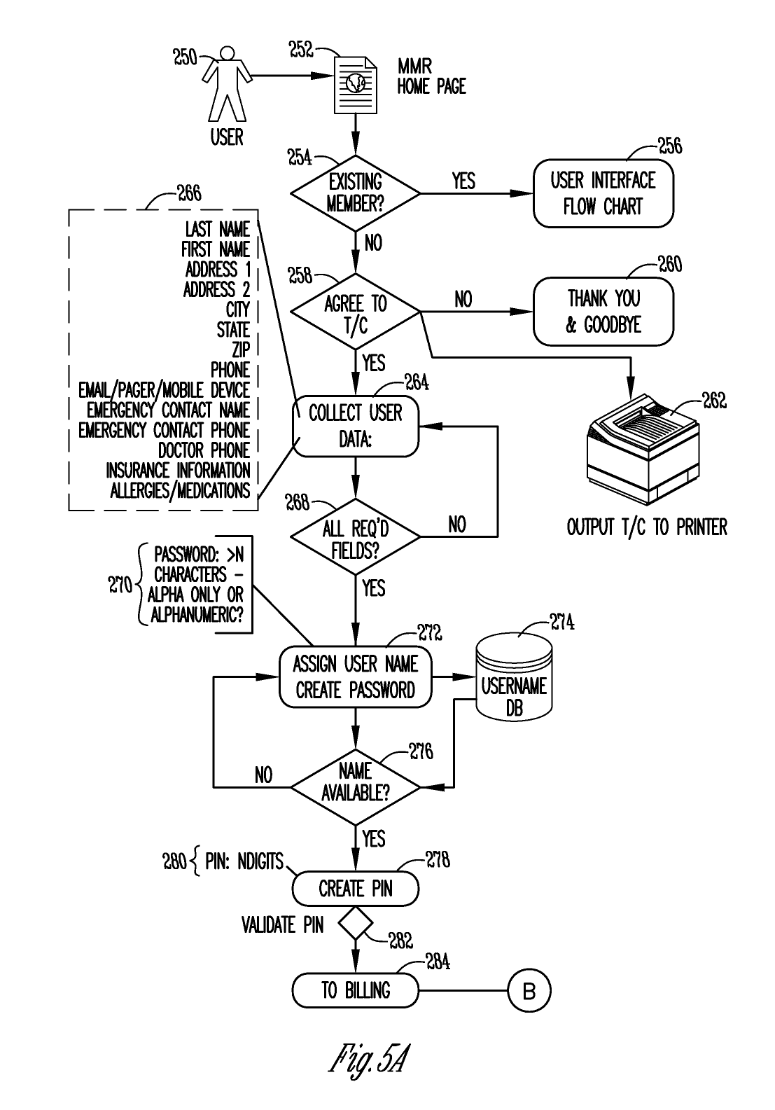

FIG. 4 illustrates one embodiment of a system of the present invention. Preferably such a system is implemented using equipment from Prairie Systems, Inc. of Omaha, Nebr., although the present invention contemplates that other vendors may be used. As shown in FIG. 4, the system 200 includes a fax/voice server 202. The fax/voice server 202 is accessible by a fax machine 204 or a phone 208 through using a dedicated phone number 206. Preferably, the phone number 206 is toll-free as this increases the accessibility and convenience of the system which is very important. However, the phone number 206 could also be a direct dial phone number. When the fax/voice server 202 receives a call, a determination is made in step 210 as to whether the call is a voice call or a fax call. Where the call is a voice call, an interactive voice response (IVR) system is used to determine who the caller is, the purpose of the call, or other information, and then stores any voicemail message in voice storage 212. The system is adapted to notify the individual that there is a voicemail message through an email notification in step 214 and/or other types of notification in step 216. Other types of notification can include, but are not limited to text messages to a cell phone or pager. Thus, a healthcare provider can call the LIFELINE number 206 and leave a voicemail message for the individual and know that the communication is a private communication. Thus, the healthcare provider can leave private and confidential information, such as the results of a test, or the need to schedule a new appointment, or other information. The individual is alerted to the presence of the voicemail message and can then call-in to the fax/voice server 202 to check messages.

Where documents are faxed, fax images are collected and converted to portable document format (PDF) documents 218. Although, the PDF format is preferred, the present invention contemplates that other types of document conversions can be done as may be appropriate in a particular implementation of the present invention. Based on the dedicated phone number 206 used to send the documents, the faxed documents are assigned to a user account and stored in step 220. The individual is alerted via email that the documents have been sent in step 224. Alternatively, the individual is alerted via text messaging in step 222 that a fax has been sent.

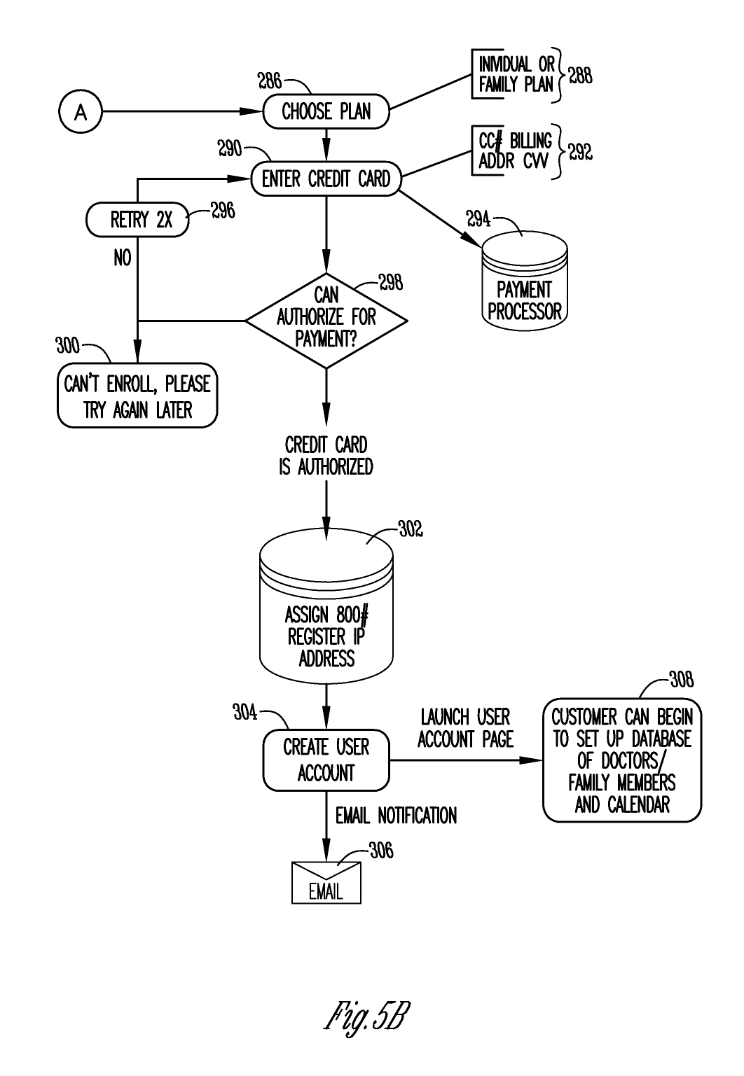

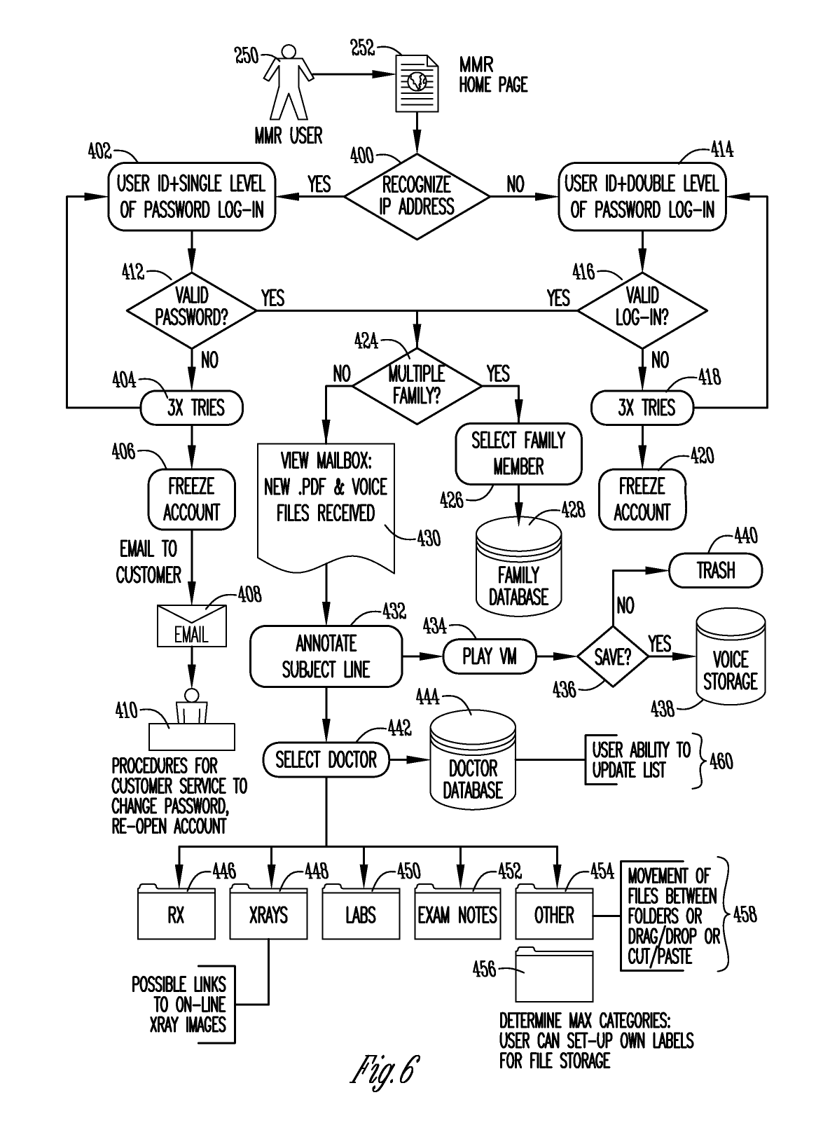

The web site of the present invention provides a convenient location to collect and store healthcare records and provide secure access to the records. It also provides a convenient way to enroll in a service for providing online access to health records. FIG. 5A and 5B provides one embodiment of an enrollment process In FIG. 5A, a user 250 accesses a home page 252 for a medical records web site. In step 254, a determination is made as to whether the user 250 is an existing member. If the member is, then in step 256 the user is provided access to their user interface as shown in FIG. 6. If not, then in step 258 a determination is made as to whether the user 250 agrees to terms and conditions of service. If not, then in step 260 the user is thanked for their interest but not allowed to continue. The user is also given the option or encouraged to output the terms and conditions to a printer in step 262 so that they can review them closely and maintain a copy for their records if they wish. If in step 258, the user agrees to the terms and conditions of service then in step 264 the system collects user data. User data 266 can include last name, first name, address information, city, state, zip code, phone number, email/pager/mobile device information, emergency contact name, emergency contact phone number, primary care physician phone number, insurance information, allergies and medications, and/or other information. If all fields are received in step 268, then in step 272 the system assigns a user name and password. It is to be understood that the user may also request a particular username and/or set their own password. Where a user selects their own password, then in step 270, a determination is made as to whether the password meets security requirements. For example, there may be a minimum number of characters required, or there must be at least one numeric character, or other requirements. Where the user is allowed to select their own name, in step 274, a username database is searched and in step 276 a determination is made as to whether or not the name is available. If it is, then in 278 the user is permitted to create a personal identification number (PIN). In step 280, a rule such as one requiring a particular number of digits or a particular minimum digits is applied. In step 282 the PIN is validated and the enrollment process proceeds to billing options in step 284. In FIG. 5B, the user is allowed to choose a plan in step 286. The individual could, for example, choose an individual or family plan from the plan options 288. In step 290, the user enters credit card information 292 which may include a credit card number, billing address, and CW number. This information is then submitted to a payment processor 294. In step 298, a determination is made as to whether the credit card information can be authorized for payment. If not, then the number of retries is determined in step 296 and the user is allowed to re-enter their credit card information in step 290. If there have already been two tries to validate credit card information, then in step 300 the individual is told that they can not enroll at this time and should try again later. If payment is authorized in step 298 then in step 302 a dedicated toll free phone number is assigned and an IP address associated with the user is registered. In step 304 a user account is created. In step 306 an email notification confirming registration is sent to the user. In step 308 the user can begin to setup their personal web site such as their database of doctors, family members, calendar, and otherwise configure their web site.

Where a calendar is used, the present invention contemplates that the calendar can be synchronized with an application such as Microsoft Outlook, a calendar program associated with a PDA, or other personal information manager.

After registration, the user can access the user interface of the web site. FIG. 6 illustrates one embodiment of the user interface 256. The user 250 can access the homepage 252. In step 400, a determination is made as to whether the system recognizes the ip address being used by the user as being associated with the user. If the ip address is not recognized then extra security measures are taken beginning in step 414. In step 414 a username and a double level of password log-in is required. If a valid log-in, then the process proceeds to step 424. If not, then in step 418, the number of invalid log-in attempts or tries is monitored and if it is three, then in step 420 the account is frozen. Returning to step 400, if the ip address is recognized as being associated with the user, then in step 402 a username and a single level of password log-in is required. In step 412 a determination is made as to whether or not the password is valid. If a valid password, then the process proceeds to step 424. If not, then in step 404 a determination is made as to the number of invalid attempts. After three invalid attempts, in step 406 the account is frozen and in step 408 an email is sent to the individual who may, in step 410, implement procedures to change the password and re-open the account.

Returning to step 424, a determination is made as to whether the account is associated with an individual or a family. If the account is associated with a family, then in step 426, the user can select the family member and access the family database 428. If, in step 424 the account is not a family account, then in step 430 the user can view their mailbox showing new PDF files and voice files. Preferably, these new files include date and time stamps so that the user can see when the files were received.

In step 432, the user is allowed to annotate the messages to better identify the messages in a manner that is convenient for the user. In step 434, the user can play the voicemail messages. In step 436, the user can choose to save the messages to voice storage 438 or to send the message to the trash 440. In step 442, the user can select a doctor to associate with the voicemail messages. For example, the doctor from which the voicemail or imaged document was received. Preferably the doctor is within the doctor database 444. If not, then in step 460, the user can update the doctor database 444 to include the doctor. The user can then organize the voicemail or document according to the user's preference into one or more file folders. Examples of file folders include RX 446, XRAYS 448, LABS 450, EXAM NOTES 452, OTHER 454. The user can make new file folders such as file folder 456 and identify it appropriately. The user interface offers functions 458 such as movement of files between folders, drag and drop, cut and paste, and/or other functions that will assist the user in organizing their records.

The present invention provides for each of the file folders to be protected with one or more additional passwords. Such an implementation is particularly useful in a number of contexts. For example, the use of multiple passwords allows information such as insurance information, financial information, or other proprietary information to be protected differently than the medical records.

Another example of where this extra layer of security can be useful is where a single account is shared by a family consisting of two parents and multiple children. Each parent may have their own folder separately password protected so that the other parent can not access their folder, but still allowing both parents to access the folders for the children.

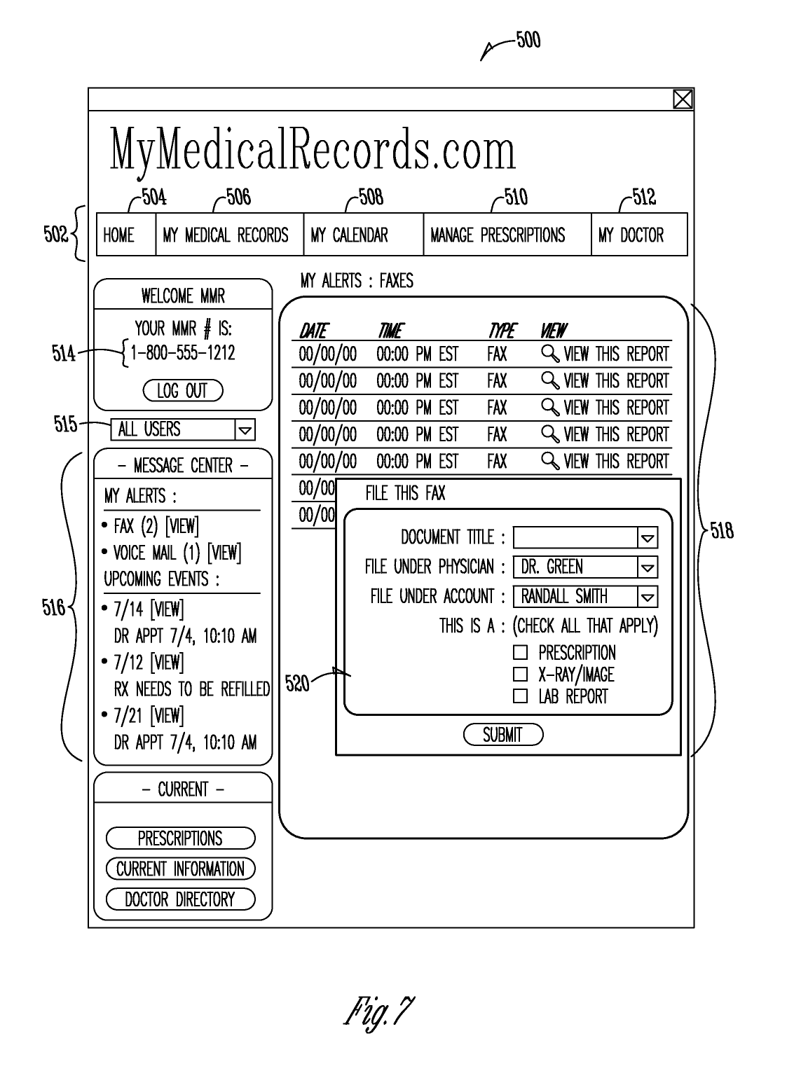

FIG. 7 illustrates one embodiment of a screen display of the present invention. In FIG. 7, the screen display 500 includes a menu bar 502 along the top with different menu items such as “Home” 504, “My Medical Records” 506, “My Calendar” 508, “Manage Prescriptions” 510 and “My Doctor” 512. The screen display 500 also includes a reminder to the individual of their LIFELINE toll free dedicated phone number 514. A message center 516 includes alerts as to recent faxes, voicemails, doctor appointments, prescription refills, or other related events. The user can view the recent faxes 518, and for each fax, can file it using fax filing options 520 which allow the user to give a document title to the fax, associate a physician with the fax, file the fax under a particular account where the account is a family account, and identify the fax as a prescription, x-ray/image, or lab report.

It should also be appreciated that a user need not fax themselves documents. Instead, the user can upload scanned documents or other files in any number of formats.

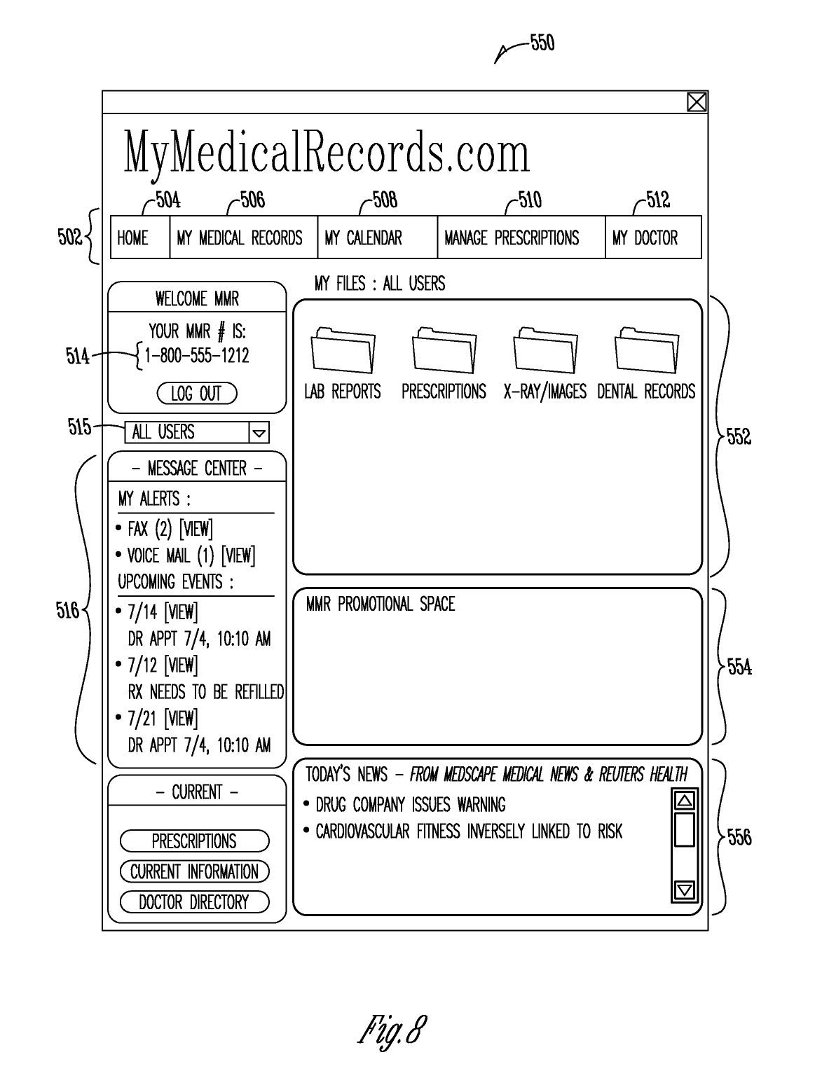

FIG. 8 illustrates another example of a screen display according to one embodiment of the present invention. In FIG. 8, the screen display 550 also includes a files section 552 wherein different folders are shown for storing and organizing information. This allows a user to store records in a manner appropriate for them. In one embodiment, the folders can include separate folders for lab reports, prescriptions, x-ray/images, dental records, lab reports, prescriptions, and all records. As shown in FIG. 8, there is a promotional space 554. The present invention allows for promotional material to be placed in the promotional space 554 that is of potential interest to the user. The promotional information can come from a third party source or advertiser. In additions, news information may be placed in a news information portion 556 of the web page. The news information can include breaking news regarding the medications that the patient is on, health and fitness news, or other news of potential interest or importance to the user.

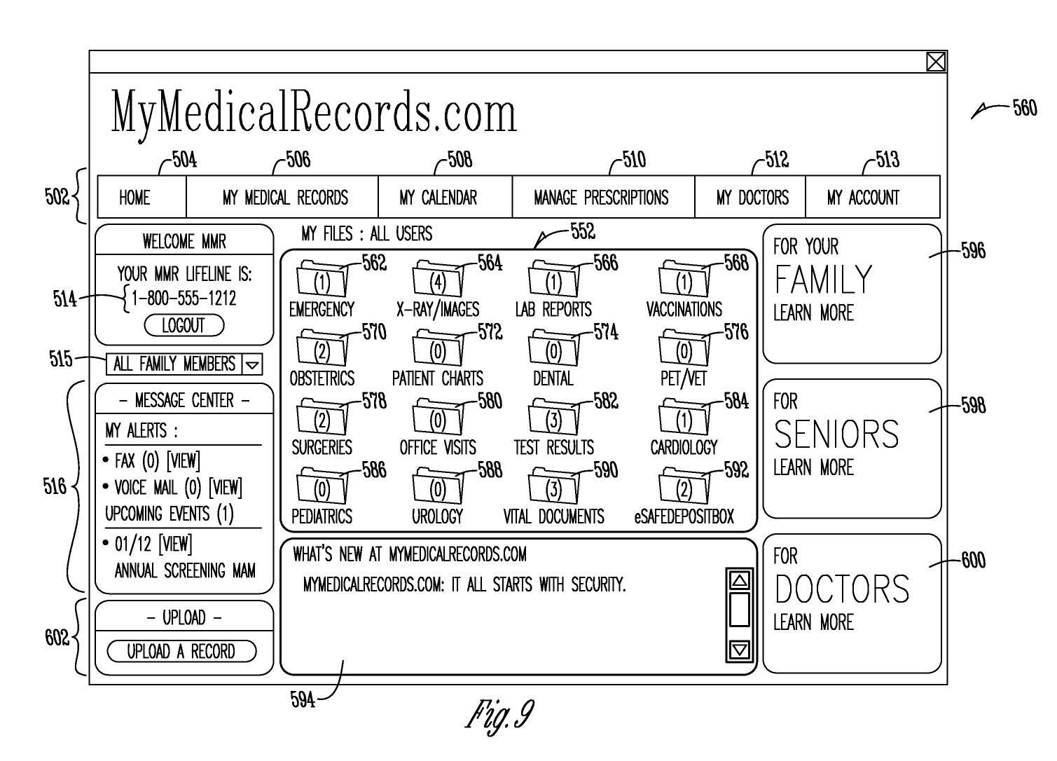

FIG. 9 is another example of a screen display 560 according to one embodiment of the present invention. Note that a MYACCOUNT option 513 is shown near the top of the screen display 560. Also note that a user is allowed to select a family member using the dropdown list box 515. There is also an upload record option 602 provided so that a user may upload files of various types directly to their account.

Shown in the MY FILES portion 552 are a plurality of file folders, including: EMERGENCY folder 562, X-RAY/IMAGES folder 564, LAB REPORTS 566, VACCINATIONS 568, OBSTETRICS 570, PATIENT CHARTS 572, DENTAL 574, PET/VET 576, SURGERIES 578, OFFICE VISITS 580, TEST RESULTS 582, CARDIOLOGY 584, PEDIATRICS 586, UROLOGY 588, VITAL DOCUMENTS 590, eSAFEDEPOSITBOX 592. The various file folders shown provide a convenient method for users to organize their files. Note that each folder indicates how many files are stored within the file folder.

A WHAT′S NEW portion 594 allows users to learn about new features or other information. A FAMILY panel 596 can display information or links to information relevant to families. A SENIORS panel 598 can display information or links to information relevant to seniors. A DOCTORS panel 600 can display information or link to information relevant to doctors. Of course, the present invention contemplates that panels 596, 598 and 600 need not be present, and where present can be used to convey other types of information of potential interest to users.

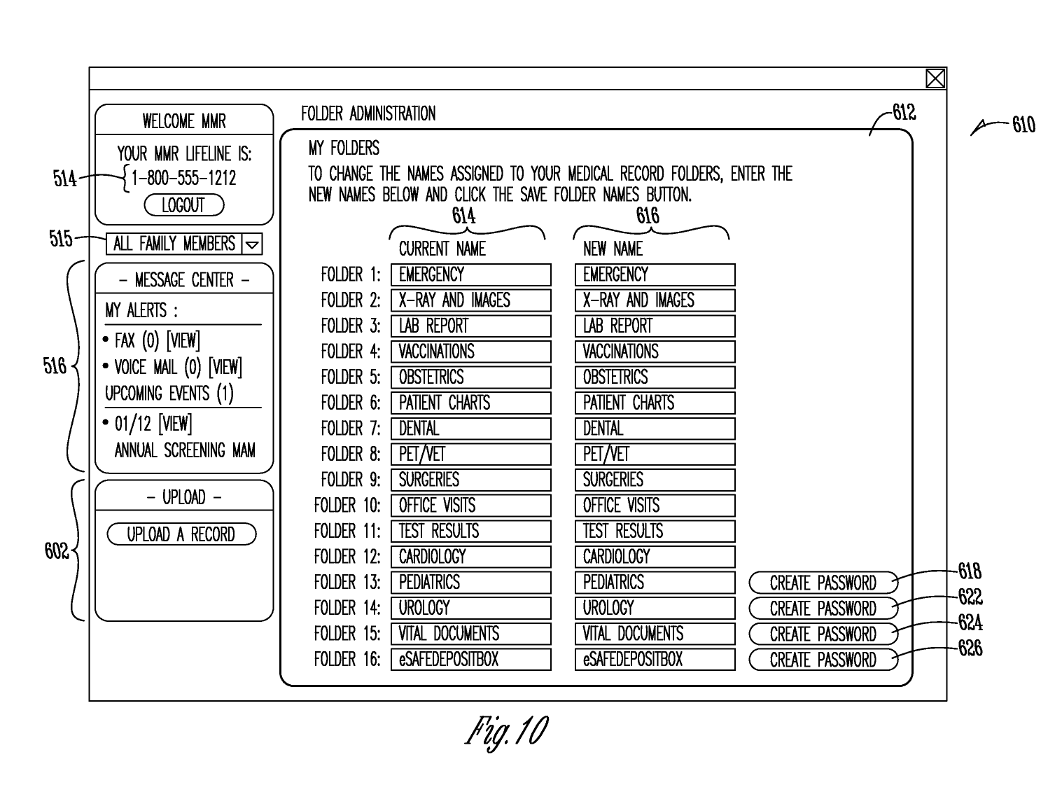

FIG. 10 is another example of a screen display according to one embodiment of the present invention. The screen display 610 allows for folder administration. A folder administration portion 612 includes a listing of multiple folders (16 shown) with a column 614 indicating the current name for each folder and a column 616 indicating the new name to be assigned to each folder. In operation a user can change the name of the folders to suit their particular needs. Note that at least a portion of the folders have a password associated with them. This provides an additional layer of security to these files.

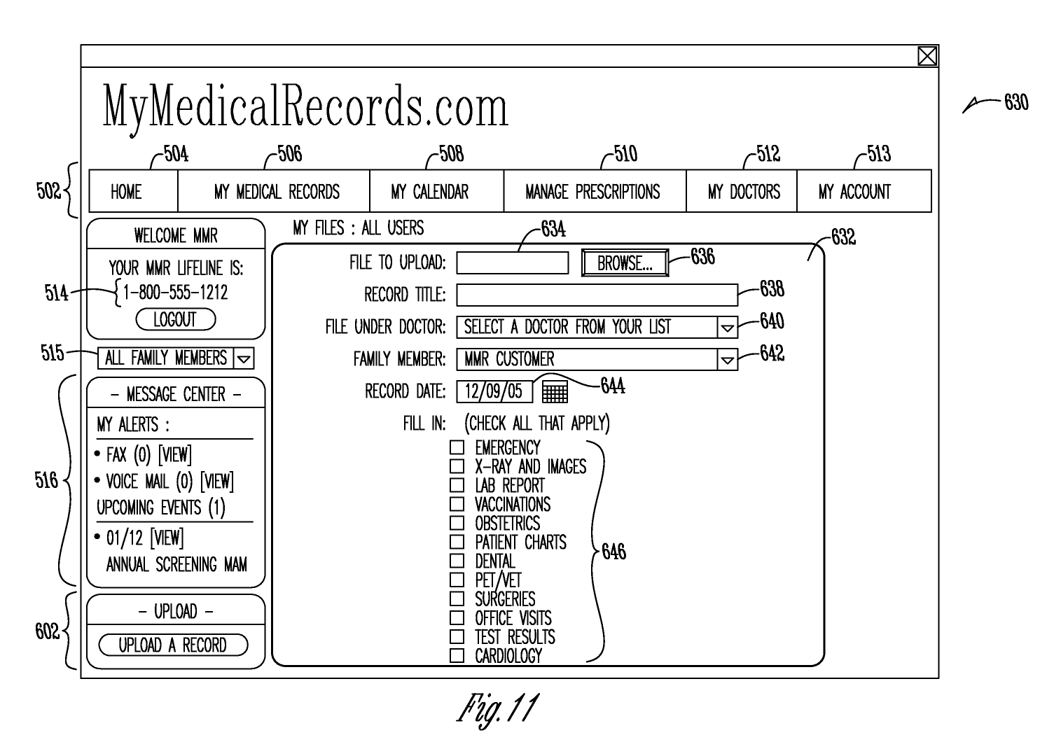

FIG. 11 is a screen display for an uploaded file feature according to another embodiment of the present invention. The screen display 630 allows for uploading a medical record 602. The upload a record window 632 allows the user to select a file to be uploaded 634 by browsing 636 to the location of the stored file. For example, if the user has chest x-rays saved in a picture format such as a jpeg, they would be able to browse 636 to the file and upload the file 634 to add to or to make current their present set of medical records. The upload a record window 632 also allows the user to record a title 638 for the file uploaded 634. Additionally, the uploaded a record window 632 allows the user to associate the file uploaded 634 with the appropriate doctor selected from a drop-down list 640. If the account is family or joint type account and allows storing medical records for multiple persons, the user may use the drop-down menu 642 to select the family member 642 to whom this newly uploaded file 634 should be associated with. The upload a record window 632 also allows the user to record a date 644 associated with the newly uploaded file 634. Lastly, the user has the option of selecting the individual folders 646 where he or she would like a copy of the newly uploaded file 634 to be saved. For example, the user may wish to save the chest x-rays in the x-ray and images folder as well as other folders, such as the emergency folder, lab report and/or surgeries folder. The upload a record window 632 allows the user to periodically update their personal medical records with important medical information and associate that information with the appropriate folders. The upload a record window 632 also makes it easy for the user to browse to and save medical files in electronic form in a convenient and organized manner.

In one embodiment, not only is a password required to access the website, but an additional password is required to access such a folder. This feature can be advantageous in a number of different situations. For example, a family may share an account, but each spouse may maintain certain files in confidence from the other. Or where healthcare information is accessed in an emergency (or through fraudulent use of an emergency card), the most private information which is protected with a second level of password protection remains secure. As shown there are buttons 618, 622, 624, 626 for providing a secondary level of password protection.

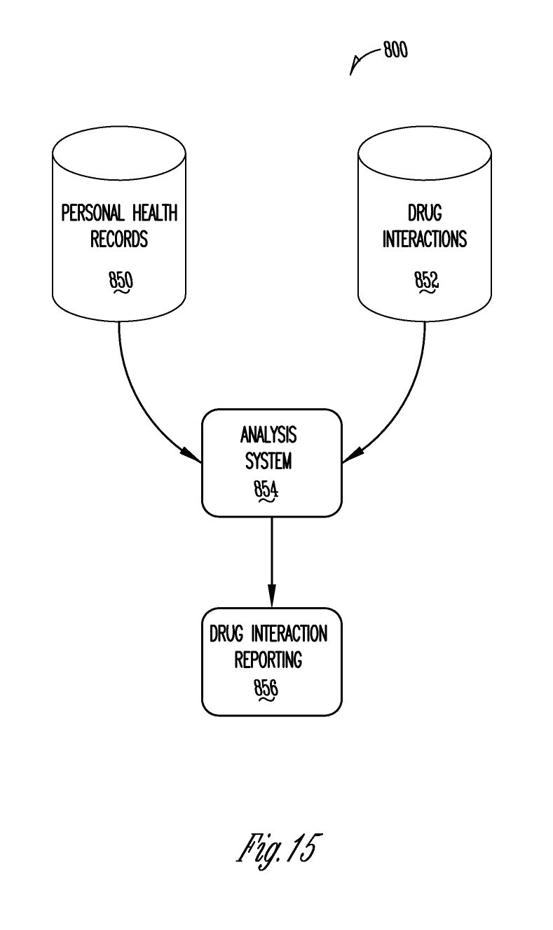

FIG. 15 illustrates one embodiment of using the health-related information collected to provide additional benefits to a consumer. For example, the present invention allows for a system 800 that includes a personal health records database 850 and a drug interactions database 852 operatively connected to an analysis system 854. The analysis system 854 is operatively connected to a drug interaction reporting component 856. The personal health records 850 includes information regarding which prescription drugs are being taken by the user. The drug interactions database 852 includes information regarding known interactions between different drugs. The analysis system 854 analyzes the prescription drugs taken by the user to determine if there is any known interaction that may be adverse in any way to the user. Based on the results of this analysis, the drug interaction reporting component 856 reports the results to the user, their pharmacist, doctor, or other healthcare provider as appropriate. The present invention contemplates that drug interaction reporting 856 can be reported in different ways to different people based on factors such as user preferences regarding the drug interacting reporting, the severity or certainty of a determined adverse drug interaction, or otherwise. The present invention contemplates that in addition to drug interaction analysis and reporting, other types of analysis and reporting can be performed on the personal health records. One of the advantages of the present invention is that it allows for a convenient method to build and maintain complete and up-to-date health records, thus allowing the personal health records to be analyzed in any number of ways.

The present invention provides for numerous other features and advantages. For example, the web site can provide reminders for doctor appointments, prescription refills, or other events through email reminders or text messaging reminders. In addition, the web site allows the user to select the option of sending information via fax to a care provider. For example, a user can fax a prescription to their pharmacy of choice. In addition, the user can fax their medical records received from one healthcare provider to another healthcare provider.

According to another embodiment of the present invention, the healthcare records can include both medical records as well as dental records. In addition, the healthcare records can include healthcare records not just for humans, but for pets as well. Thus, a family could manage healthcare records for every member of the family, including one or more pets.

According to another aspect of the present invention, other vital records are also stored on the web site. Examples of other types of vital records include wills, living wills, healthcare power of attorneys, and related information.

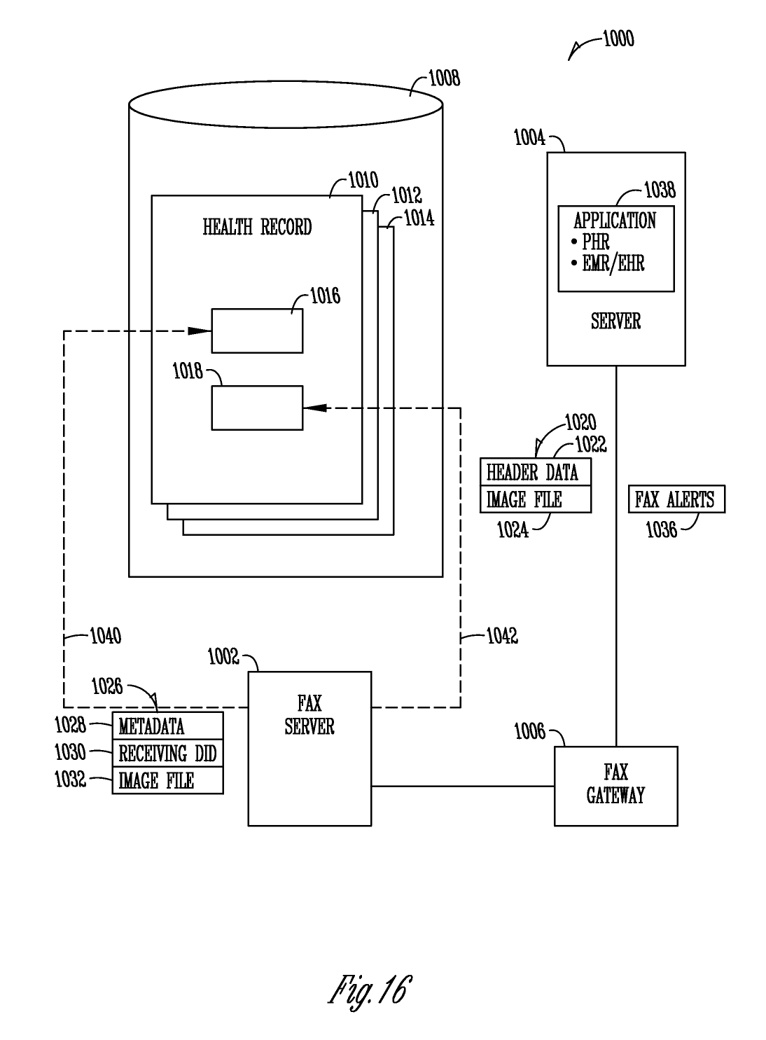

FIG. 16 illustrates one example of a system which provides for sending and receiving faxes from a health record or into a health record. In FIG. 16, a system 1000 is shown. The system 1000 includes a fax server 1002 that is used in sending and/or receiving faxes. A server 1004 (which may be a web server or application server) is in operative communication with the fax server 1002 such as through a fax gateway 1006.

The server 1004 also has access to a database 1008 preferably stored on a computer readable storage medium which includes a plurality of health records 1010, 1012, 1014. The health records 1010, 1012, 1014 in the database 1008 may be associated with any number of types of health information technology systems including those for managing electronic health records, electronic medical records, or personal health records. The health records may include images or information associated with or acquired from faxes. Thus, fax data 1016 may be introduced into or create a new health record. In addition, health records or health data 1018 may be used to construct an outgoing fax. To better demonstrate information flow, note that lines 1040, 1042 are connected between health data 1016, 1017 and the fax server 1002 to show respective source of data being in operative communication with the respective destination of the data and not necessarily the complete path of the data. Note that this information would preferably be communicated through the server 1004 and/or the fax gateway 1006 to the fax server 1002.

When an outgoing fax is to be sent information 1020 is assembled which may include header data 1022 and an image file 1024. The image file may be a PDF, TIFF, or other type of image file which provides a visual representation of health data. In the process of constructing the image file 1024 information may be added to the health data 1018 by the application 1028. The additional information may include a fax cover sheet identifying the source of the data, a patient associated with the data, a health care provider sending the data, a health care provider to receive the data, or other information. The information may further include relevant dates and times regarding when the data was collected or the time that the information is being sent. In addition to including human-readable data, the information may also include bar codes encoding information in a machine readable format.

The fax server 1002 may receive an incoming fax and then distribute it. The fax server may send information 1026 which may include metadata 1028, a receiving direct-inward-dialing (DID) phone number to which a fax was directed, and image file 1032. The image file may be a PDF, TIFF, or other type of image file which provides a visual representation of health data. The metadata 1028 may include the telephone number to which the fax was sent. This may be used for identifying a user account associated with the data. The metadata 1028 may include a filename associated with the image file, the number of pages in the document, the size of the document, the date and time the fax was received, and a sending phone number. In addition, the metadata 1028 may include information extracted from the image file, for example, information extracted through optical character recognition (OCR), information obtained by decoding bar codes (including one-dimensional bar codes, two-dimensional bar codes, QR codes, or other types of bar codes), information from characteristics or file properties, or information otherwise extracted from the image file.

Fax alerts 1036 may be communicated from the fax server 1002 to the server 1004. The fax alerts 1036 may occur to indicate that a fax has failed after one or more attempts. The fax alert 1036 may include a date or time of last retry and/or a status explanation of the last retry such as “Line Busy”, “No answer”, “Disconnected” or “Voice Line”. In addition, fax alerts may be used to confirm delivery of an outgoing fax.

The server 1004 may be operating an application 1038 stored on a computer readable storage medium. The application 1038 may be a health care information system associated with personal health records, electronic medical records, electronic health records or other types of health records.

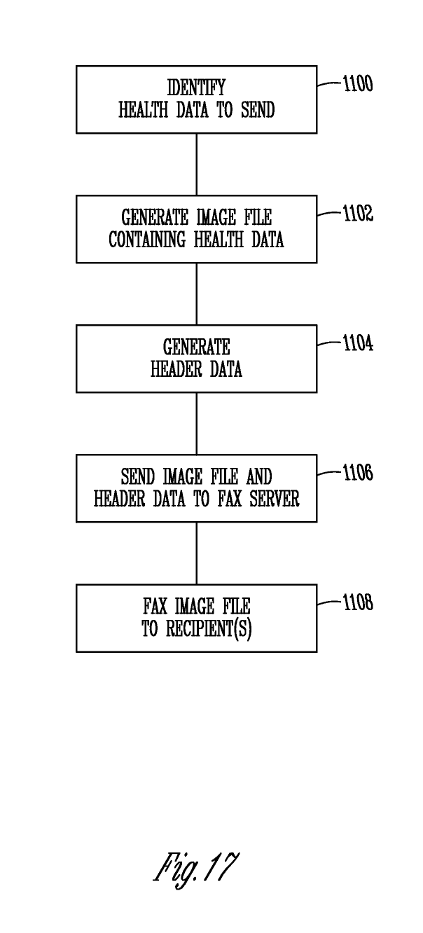

FIG. 17 illustrates one example of a method for faxing outgoing health data. In step 11—health data to send as a part of an outgoing fax is identified. The health data can be identified in various ways as may be appropriate in a particular health information technology system. One way the health data can be identified is by having a user select one or more health records through a user interface. Alternatively, the health data can be automatically identified through additional intelligence in the health information technology system, such as recognizing that new health records for a particular patient should always be faxed to a primary physician for the patient, or automatically faxing a prescription for a patient to a preferred pharmacy for the patient. Once the health data has been identified in step 1100, in step 1102 an image file containing the health data is generated in step 1102. The image file may be generated in various ways such as by using a printer driver to create the image file, or otherwise constructing the image file. It is noted that information in addition to the health data selected in step 1100 may be added to the image file. For example, the image file may also include a fax cover sheet with various information fields such as to, from, regarding, time and date fields, patient identification information, number of pages for the fax, and related information. The image file itself may be of any number of types of formats such as PDF, TIFF, or other format. Information may include machine readable data (such as bar codes) and/or human readable data.

In step 1104, header data or other meta data is generated. The header data can include the number to which a document is to be faxed or destination number. The header data can include a source which may an identifier of a user account associated with an application. Other header data may include the name of the image file, the name of the application from which data was received, a job identifier, or other information.

In step 1106, the image file and header data is communicated to a fax server. This communication may, but need not, occur through a fax gateway. Once this information is received, the image file may then be faxed to one or more recipients in step 1108.

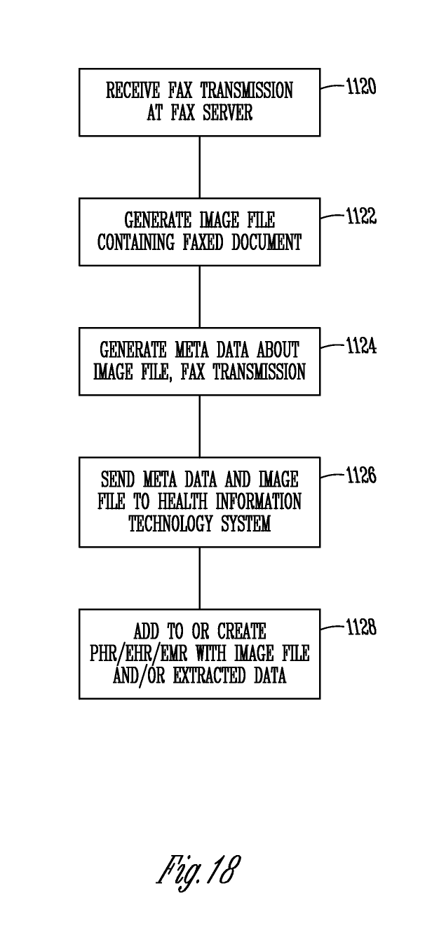

FIG. 18 illustrates one example of a method for receiving an incoming fax into a health record. In step 110, a fax transmission is received at a fax server. In step 1122 an image file is generated containing a faxed document. The image file may be in any number of formats such as PDF or TIFF. In step 1124, meta data is generated about the image file and/or the fax transmission. This meta data may include, without limitation, a direct-inward-dialing (DID) phone number to which the fax was directed, file size, file name, file creation date and time, sending phone number, number of pages in document, and/or other information. In addition, the metadata may include information extracted from the image, such as information abstracted through OCR, information obtained from decoding bar codes, or other information. The meta data, where present, may be separated into multiple different fields. For example, the DID phone number may have its own separate field in instances where doing so may aid in efficiently identifying a user account associated with the data.

In step 1126, the meta data and image file are sent to a health information technology system such as over a computer network. In step 1128, a record of the health information technology system is created or added to. The record may be a personal health record, an electronic health record, an electronic medical record, or other type of health record. Thus, a new record is created, or an existing record is modified to include the image file and/or information extracted from the image file.

Therefore methods, apparatus, and systems have been described for assisting with the interoperability of health records such as by sending and receiving faxes into or from health records of various types have been disclosed. Although specific embodiments have been shown and described, it is to be understood that the present invention contemplates numerous variations, options, and alternatives.

What is claimed is:

1. A method for receiving a fax into a personal health record, the method comprising:
receiving a fax transmission at a fax server, the fax transmission including a faxed document;
generating an image file containing the fax document;
generating meta data about the image file and/or the fax transmission;
sending the image file and the meta data to a health information technology system;
adding or creating a personal health record associated with the health information technology system using a computer associated with the health information technology system such that the personal health record comprises the image file and/or information derived from the image file.

2. The method of claim 1 wherein the meta data comprises a phone number to which the fax transmission was sent.

3. The method of claim 2 wherein the personal health record comprises the image file and text information extracted from the image file.

4. The method of claim 3 wherein the image file is a portable document format (pdf) file.

5. The method of claim 1 further comprising determining a user account associated with the faxed document.

6. The method of claim 5 further comprising making available the personal health record through the user account.

7. The method of claim 6 wherein the meta data comprises a phone number to which the fax transmission was sent.

8. The method of claim 7 wherein the determining the user account associated with the faxed document is based on the phone number.

9. A method for receiving a fax into an electronic health record, the method comprising:
receiving a fax transmission at a fax server, the fax transmission including a faxed document;
generating an image file containing the fax document;
generating meta data about the image file and/or the fax transmission;
sending the image file and the meta data to a health information technology system;
adding or creating an electronic health record associated with the health information technology system such that the electronic health comprises the image file and/or information derived from the image file.

10. The method of claim 9 wherein the image file is in a pdf format.

11. The method of claim 9 wherein the meta data comprises data about the fax transmission.

12. The method of claim 11 wherein the data about the fax transmission comprises a destination phone number for the fax transmission.

13. The method of claim 9 wherein the meta data comprises data extracted from the image file.

14. The method of claim 9 wherein the electronic health record is a personal health record or an electronic medical record.

15. A method for sending a fax based on an electronic health record within a health information technology system, the method comprising:
identifying health data in one or more electronic health record within the health information technology system to send;
generating an image file containing the health data;
generating header data associated with the image file;
sending the image file and the header data to a fax server; and
faxing the image file to one or more phone numbers associated with recipients.

16. The method of claim 15 wherein the image files is in a pdf format.

17. The method of claim 15 wherein the header data includes the one or more phone numbers to send the image file to.

18. The method of claim 15 wherein the step of generating the image file containing the health data includes generating a fax cover page.

19. A method for providing a user with the ability to access and collect health records associated with the user in a secure and private manner, the method comprising:
associating access information with the user for the user to use to access a server storing files comprising health records associated with the user in a computer readable storage medium;
providing the user with a user interface on a computing device to remotely access the health records stored on the server;
receiving at the server the files comprising the health records associated with the user from a health care provider associated with the user, wherein the files include files generated from a fax transmission and wherein meta data associated with the files identifies the user;
receiving at the server a request from the user made through the user interface of the computing device for access to the files, wherein the access information is associated with the request;
sending the user a file containing the health records associated with user from the server to the computing device in response to the request;
wherein the files are maintained on the server independently from any files maintained by the health care provider and wherein the files are managed privately by the user independently from the health care provider.
